(19) United States
(12) Patent Application Publication
(10) Pub. No.: US 2022/0051270 A1
(43) Pub. Date: Feb. 17, 2022

(54) EVENT ANALYSIS BASED ON TRANSACTION DATA ASSOCIATED WITH A USER

(71) Applicant: Capital One Services, LLC, McLean, VA (US)

(72) Inventors: Abdelkader M'Hamed BENKREIRA, New York, NY (US); Joshua EDWARDS, Philadelphia, PA (US); Michael MOSSOBA, Arlington, VA (US)

(21) Appl. No.: 16/947,731

(22) Filed: Aug. 13, 2020

(51) Int. Cl. G06Q 30/02; G06Q 10/10; G06N 20/00; G06Q 20/38; G06F 40/40

(52) U.S. Cl. CPC G06Q 30/0202; G06Q 10/109; G06F 40/40; G06Q 20/389; G06N 20/00

(57) ABSTRACT

A device may receive event data associated with a calendar event of a digital calendar of a user and determine, using a machine learning model, a transaction score associated with a probability that the calendar event involves an event transaction. The machine learning model may be trained based on calendar data associated with historical calendar events and transaction data associated with historical transactions. The device may cause, based on the transaction score satisfying a score threshold, the machine learning model to analyze a transaction log of a transaction account of the user to identify transaction information associated with the calendar event. The device may perform an action associated with the transaction information and the calendar event.

### BACKGROUND

A user may conduct transactions using funds of a transaction account. A financial institution, associated with the transaction account, may monitor the transaction account and the transactions for the purpose of determining whether the transactions are valid or fraudulent. The financial institution may authorize transactions that are valid and decline transactions that are fraudulent.

### SUMMARY

In some implementations, a method includes: receiving, by a device, access information associated with analyzing calendar data in association with a transaction analysis, wherein the calendar data is associated with a digital calendar of a user; identifying, by the device and from the calendar data, event data of a calendar event on the digital calendar; determining, by the device and using a transaction event recognition model, a transaction score associated with a probability that the calendar event is associated with an event transaction, wherein the transaction event recognition model includes a first machine learning model that is trained to identify calendar events that involve event transactions; causing, by the device and based on the transaction score satisfying a score threshold, a transaction analysis model to analyze a transaction log of a transaction account of the user to identify a transaction value associated with the event transaction, wherein the transaction analysis model includes a second machine learning model that is configured to identify a transaction pattern associated with timing of the calendar event and determine the transaction value from transactions of the transaction pattern; and performing, by the device, an action associated with the transaction value and the calendar event.

In some implementations, a device includes one or more memories; and one or more processors, communicatively coupled to the one or more memories, configured to: monitor calendar data of a digital calendar associated with a user; identify, from the calendar data, event data of a calendar event on the digital calendar; determine, using a transaction event recognition model, a transaction score associated with a probability that the calendar event is associated with an event transaction, wherein the transaction event recognition model is trained based on calendar data associated with historical calendar events and first transaction data associated with first historical transactions; cause, based on the transaction score satisfying a score threshold, a transaction analysis model to determine transaction information associated with the calendar event based on an analysis of a transaction log of a transaction account of the user, wherein the transaction analysis model is trained based on second transaction data associated with second historical transactions; and perform, based on the transaction information, an action associated with forecasting a status of the transaction account during a time period of the calendar event.

In some implementations, a non-transitory computer-readable medium storing instructions includes one or more instructions that, when executed by one or more processors, cause the one or more processors to: receive event data associated with a calendar event of a digital calendar of a user; determine, using a machine learning model, a transaction score associated with a probability that the calendar event involves an event transaction, wherein the machine learning model is trained based on calendar data associated with historical calendar events and transaction data associated with historical transactions; cause, based on the transaction score satisfying a score threshold, the machine learning model to analyze a transaction log of a transaction account of the user to identify transaction information associated with the calendar event; and perform an action associated with the transaction information and the calendar event.

### BRIEF DESCRIPTION OF THE DRAWINGS

FIGS. 1A-1C are diagrams of one or more example implementations described herein.

FIG. 2 is a diagram illustrating an example of training and using a machine learning model in connection with event analysis based on transaction data associated with a user.

FIG. 3 is a diagram of an example environment in which systems and/or methods described herein may be implemented.

FIG. 4 is a diagram of example components of one or more devices of FIG. 3.

FIG. 5 is a flowchart of an example process relating to event analysis based on transaction data associated with a user.

### DETAILED DESCRIPTION

The following detailed description of example implementations refers to the accompanying drawings. The same reference numbers in different drawings may identify the same or similar elements.

A user of a user device may conduct transactions (e.g., by interacting with a plurality of merchants (e.g., providers of goods and/or services)). The transactions may be conducted using funds of a transaction account of the user. A financial institution, associated with the transaction account, may be interested in determining whether the transactions are valid or fraudulent. One technique that the financial institution may use to determine whether transactions are valid or fraudulent is to monitor and analyze the transactions. The financial institution may perform thousands, millions, or more such fraud analyses of transactions every day.

In some instances, a fraud analysis performed by the financial institution can involve a plurality of examinations of characteristics of the transactions and/or the transaction account associated with the transactions. For example, the fraud analysis can include an examination of a transaction history of the user, an examination of costs of the transactions, an examination of the type of the transactions (e.g., online, in-person, use of a transaction, use of cash, and/or the like), an examination of locations of the transactions, and/or the like.

In some instances, the user may conduct transactions due to some events (e.g., calendar events) that do not typically occur (e.g., anniversaries, social gatherings, unexpected travels, and/or the like). For example, such transactions may include purchasing anniversary gifts, social gathering gifts (e.g., birthday gifts), plane tickets, and/or the like. The financial institution may perform a fraud analysis with respect to such transactions (e.g., an examination of such transactions with respect to the transaction history of the user, with respect to historical transactions costs, with respect to historical transaction locations, and/or the like).

Based on the fraud analysis, the financial institution may determine that such transactions are atypical transactions. Accordingly, the financial institution may erroneously determine that such atypical transactions are fraudulent transactions and may erroneously contact the user to notify the user of the fraudulent transactions. Accordingly, the financial institution may waste computing resources, network resources, and/or the like used to erroneously determine that the atypical transactions are part of a fraudulent activity, investigate the fraudulent activity, report the fraudulent activity, contact the user regarding the fraudulent activity, take remedial measures with respect to erroneously determining that the atypical transactions are fraudulent, and/or the like.

Some implementations described herein provide a transaction event management platform that monitors calendar events and predicts transactions (e.g., purchases) associated with the calendar events and values associated with the transactions. For example, the transaction event management platform may use one or more machine learning models to determine whether a calendar event involves a transaction and predict a value (e.g., monetary value) of the transaction.

The transaction event management platform may monitor calendar data of a digital calendar associated with a user. The transaction event management platform may identify, from the calendar data, event data of a calendar event on the digital calendar and may determine, using a first machine learning model, a transaction score associated with a probability that the calendar event is associated with an event transaction. As used herein, an “event transaction” may refer to a transaction that is related to a calendar event (e.g., a transaction that may be triggered by a calendar event).

The transaction event management platform may cause, based on the transaction score satisfying a score threshold, a second machine learning model to determine transaction information associated with the calendar event based on an analysis of a transaction log of a transaction account of the user. In some implementations, the transaction information may include information regarding the event transaction (e.g., a cost of the event transaction, a time when the cost is going to be incurred, and/or the like).

By determining, using machine learning models, a transaction score associated with a probability that a calendar event is associated with an event transaction and by determining transaction information associated with the calendar event, the transaction event management platform may preserve computing resources, network resources, and/or the like that would have otherwise been used to erroneously determine that transaction (associated with calendar events) are part of a fraudulent activity, investigate the fraudulent activity, report the fraudulent activity, contact a user regarding the fraudulent activity, take remedial measures associated with determining that transactions are fraudulent, and/or the like.

Additionally, by determining the transaction score and determining the transaction information, the transaction event management platform may improve the reliability of identifying valid transactions and fraudulent transactions, thereby preserving computing resources, network resources, and/or the like that would have otherwise been used to erroneously identify valid transactions and fraudulent transactions.

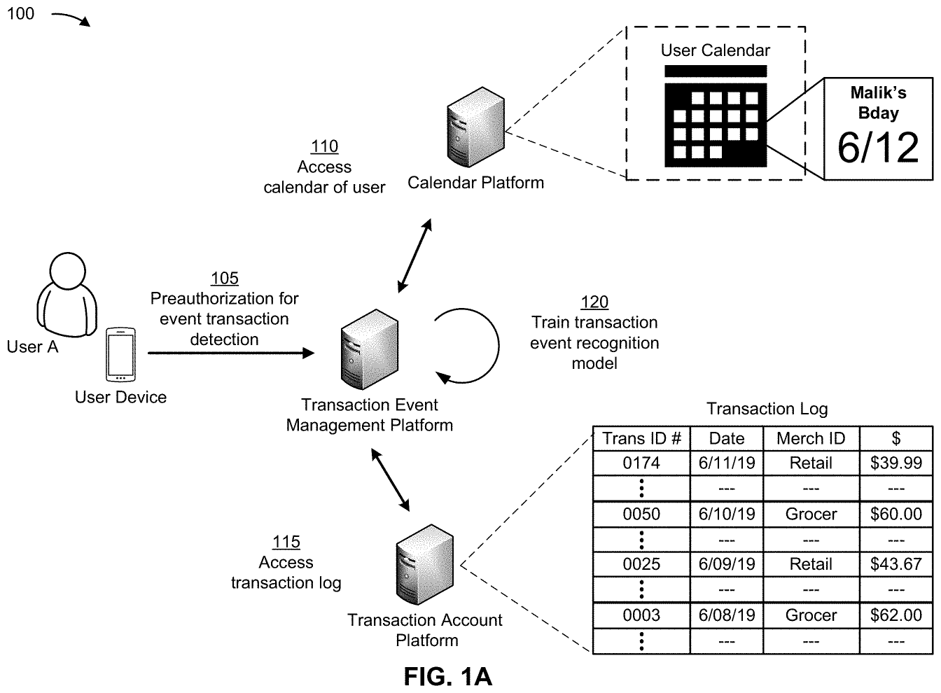

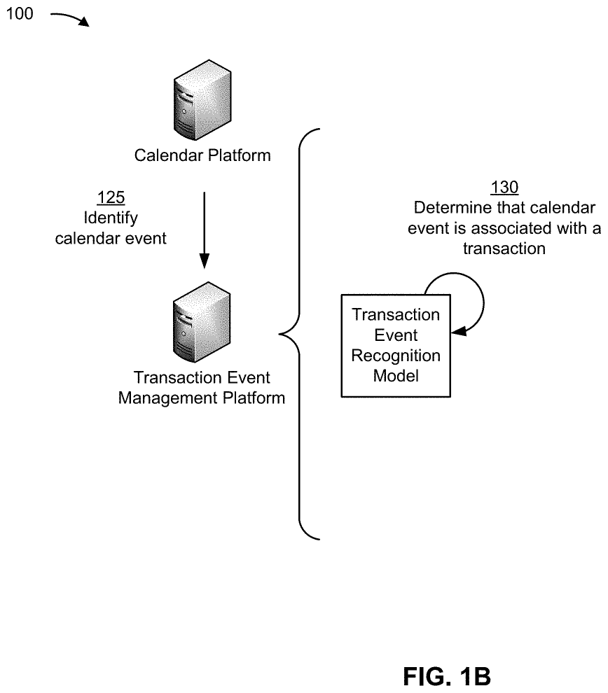

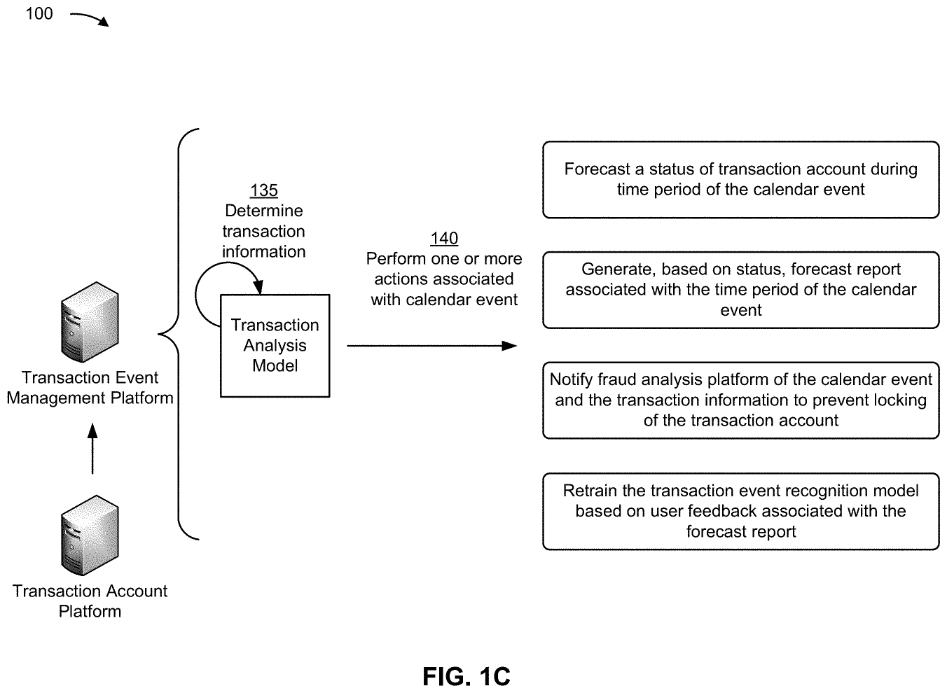

FIGS. 1A-1C are diagrams of one or more example implementations 100 associated with event analysis based on transaction data associated with a user. As shown in FIGS. 1A-1C, example implementations 100 include a transaction event management platform, a user device, a calendar platform, and a transaction account platform. The transaction event management platform may include one or more devices that forecast transactions based on calendar events. The user device may include a mobile device, computer, and/or the like, and may be associated with a user.

The calendar platform may include one or more devices that store information regarding a plurality of digital calendars (e.g., electronic calendars) associated with a plurality of users (including the user of the user device). The information regarding the digital calendars may include calendar data identifying calendar events associated with the plurality of users. The transaction account platform may include one or more devices that store information regarding transaction accounts associated with the plurality of users. The information regarding the transaction accounts may include one or more transaction logs that include information identifying transactions (e.g., purchases, leases, rentals, and/or the like) associated with the plurality of users, information associated with bank accounts of the plurality of users, information associated with transaction cards of the plurality of users, and/or the like. In some implementations, the transaction account platform may maintain bookkeeping information (e.g., associated with a bookkeeping application) that identifies all transactions of the plurality of users (e.g., transactions using transaction card, using cash, and/or the like).

As further shown in FIG. 1A, and by reference number 105, the transaction event management platform may receive a preauthorization for an event transaction detection. For example, the transaction event management platform may receive, from the user device, the preauthorization to detect an event transaction associated with a calendar event. In some implementations, when receiving the preauthorization, the transaction event management platform may receive, from the user device, access information associated with monitoring and/or analyzing a digital calendar (e.g., an electronic calendar) of the user and a transaction account of the user. The digital calendar may include calendar data identifying calendar events associated with the user and the transaction account may include a transaction log identifying transactions associated with the user.

The access information may correspond to a user input that authorizes access to the digital calendar and the transaction account (including the transaction log) in order to monitor and/or analyze the digital calendar and the transaction account. The access information may enable an application programming interface (e.g., of the transaction event management platform) to access the digital calendar and the transaction account. In some implementations, the access information may include user information of the user (e.g., credentials) to access the digital calendar and/or the transaction account. The credentials may include a username, a password, a personal identification number, a security token, a biometric, and/or the like associated with the user.

In some implementations, the transaction event management platform may receive the access information based on requesting the access information from the user device (e.g., by providing a prompt via a display associated with the user device), based on the user of the user device providing the access information (e.g., via a user interface, via an application installed on the user device, and/or the like), and/or the like. According to some implementations, the transaction event management platform may perform a verification process to verify that the user that provided the access information is an authorized user of the user device and/or an authorized user associated with the digital calendar of the user and the transaction account of the user described herein.

The verification process may include requesting and processing credentials (e.g., a username, password, personal identification number, and/or the like) associated with an authorized user, personal information associated with an authorized user, security information associated with an authorized user, biometric information associated with an authorized user, and/or the like to authenticate the user. In some implementations, the transaction event management platform may utilize a two-factor authentication process to receive the access information from the user. The two-factor authentication process may increase a security of providing the transaction event management platform with access to an account associated with the user by providing the transaction event management platform with limited access to the account, by providing the user of the user device with control over whether the transaction event management platform can access the account, and/or the like.

The verification process and/or the two-factor authentication process adds an additional level of security to any action performed by the transaction event management platform and/or the user device. Verifying the identity of the user before allowing access to an account associated with the user and/or executing a transaction associated with the missed transaction prevention service allows for early identification of fraudulent activity. Verifying the identity of the user allows the transaction event management platform to conserve user device computing resources that would have otherwise been used to perform the transaction, identify the fraudulent activity, investigate the fraudulent activity, and/or report the fraudulent activity.

In some implementations, the access information may permit the transaction event management platform to access a browser and/or software application associated with the user (e.g., a client application on the user device or another device associated with the user, a server application serving a client application of the user device, and/or the like) for monitoring online activity, social media activity, and/or the like. In some implementations, the transaction event management platform may prompt the user of the user device to permit the transaction event management platform to access the browser and/or software application associated with the user. In some implementations, after receiving the access information, the transaction event management platform may access the browser and/or software application to monitor the user's online activity, social activity, and/or the like.

To maintain privacy of a user, the transaction event management platform may ensure that the user opts in (e.g., via the preauthorization and/or the access information) to enable the transaction event management platform to access the digital calendar and the transaction account, to monitor the digital calendar and the transaction log associated with the transaction account, to monitor online and social media activities, to monitor and/or access private information of the user, and/or the like. Accordingly, the transaction event management platform may be configured to abide by any and all applicable laws with respect to maintaining the privacy of the user and/or content of the digital calendar, the transaction account, and/or the like. In some implementations, the transaction event management platform may not download (or permanently store) any calendar data, transaction information, audio or image files or data, and/or the like, from the user device, the transaction event management platform may anonymize and/or encrypt any private information associated with the user and/or accounts, calendar data, messages, images, audio, and/or the like of the user, and/or the like.

In some implementations, the transaction event management platform may have or may be configured to have limited access to the digital calendar, the transaction account, images or audio associated with the user, and/or the like. For example, the transaction event management platform may be configured to have access to the digital calendar and the transaction account periodically and for a threshold time period and/or to a limited number of most recently posted calendar events and transactions (e.g., the last ten transactions, twenty transactions, and/or the like). According to some implementations, the user may specify which information and/or the types of information that the transaction event management platform may have access to and/or receive.

As further shown in FIG. 1A, and by reference number 110, the transaction event management platform may access a calendar of the user. For example, the transaction event management platform may use the access information (e.g., received from the user device) to access the digital calendar of the user. The digital calendar may include a work calendar, a personal calendar, and/or the like. In some implementations, the transaction event management platform may transmit a request (e.g., including the access information) to the calendar platform to access the digital calendar. The calendar platform may authenticate the transaction event management platform (e.g., based on the access information included in the request).

In some implementations, the calendar platform may identify information regarding the digital calendar associated with the user (out of the information regarding the plurality of digital calendars associated with the plurality of users). For example, the access information may include information identifying the user and the calendar platform may identify the information regarding the digital calendar associated with the user based on the information identifying the user. In this manner, the calendar platform may pre-process the information regarding the plurality of digital calendars to reduce the amount of information to be processed by the transaction event management platform. By reducing the amount of information to be processed by the transaction event management platform, the transaction event management platform may conserve computing resources and/or network resources that may otherwise by consumed by processing the information regarding digital calendars associated with other users that could have been filtered out as irrelevant.

The calendar platform may authorize the transaction event management platform to analyze and monitor the digital calendar of the user based on the calendar platform authenticating the transaction event management platform (e.g., based on the access information) and identifying the information regarding the digital calendar associated with the user. In some implementations, the calendar platform may provide the information regarding the digital calendar to the transaction event management platform. Additionally, or alternatively, the calendar platform may enable the transaction event management platform to access the information regarding the digital calendar stored on the calendar platform. The information regarding the digital calendar may include calendar data identifying calendar events associated with the user. The transaction event management platform may analyze the calendar data to identify characteristics of the calendar events associated with the user.

For example, the transaction event management platform may analyze the calendar data to identify (as characteristics of a calendar event) a title, a description, a period of time (e.g., a start date, a start time, an end date, an end time), a location, one or more participants (e.g., invitees), a type (e.g., entertainment, travel, meal, and/or the like), a category (e.g., personal, business, and/or the like), a merchant, and/or the like associated with the calendar event. As an example, as shown in FIG. 1A, the calendar data for a calendar event may include “Malik's Bday” as a title, “Celebration of Malik's birthday” as a description, “6/12” as the period of time, “Winter Garden Park” as the location, and “Mom, Dad, Sisters, and Malik” as participants.

In some implementations, the transaction event management platform may process the calendar data using a combination of processing techniques (e.g., after pre-processing the calendar data) to identify characteristics of calendar events. For example, the transaction event management platform may process the calendar data using a text processing technique (e.g., a natural language processing technique, a text analysis technique, and/or the like), a code processing technique, and/or the like. In some implementations, the transaction event management platform may process the calendar data using an image processing technique (e.g., a computer vision technique, an optical character recognition (OCR) technique, and/or the like to identify text corresponding to the calendar events of the calendar data) and identify characteristics of calendar events.

In some implementations, when processing the calendar data using the text processing technique, the transaction event management platform may process text of entries in the calendar data to identify terms, phrases, and/or the like included in the text. The transaction event management platform may use the terms, phrases, and/or the like to identify the characteristics of calendar events. In some implementations, when processing the calendar data using the code processing technique, the transaction event management platform may process code associated with the calendar data to identify the characteristics of calendar events. For example, the transaction event management platform may analyze code (e.g., hypertext markup language (HTML) code, cascading style sheet (CSS) code, and/or the like) associated with the calendar data and/or transaction account platform, tags within the code (e.g., a div tag, an image tag, text-related tags, and/or the like) that are associated with the calendar events, metadata, and/or the like to identify the characteristics of calendar events.

In some implementations, as a result of processing the calendar data using the combination of processing techniques, the transaction event management platform may identify calendar events associated with event transactions based on the characteristics of the calendar events, as explained in more detail below.

In some implementations, as a result of processing the calendar data using the combination of processing techniques, the transaction event management platform may convert data from a plurality of different formats to data in a uniform format. For example, the calendar data may include text in the plurality of different formats. The transaction event management platform may convert the text (e.g., using the text processing technique) to the uniform format. For example, the transaction event management platform may convert “Bday” to “birthday,” convert “Mom” to “Mother,” and/or the like.

In some implementations, the transaction event management platform may determine a type of the one or more participants using the combination of processing techniques discussed above. For example, the transaction event management platform may determine a relationship between the user and the one or more participants. For instance, the transaction event management platform may determine whether a participant is a family member, an authorized user of the transaction account, a co-worker, a business associate, an unauthorized user of the transaction account, and/or the like.

For example, the transaction event management platform may compare information identifying a participant (e.g., identified based on analyzing the calendar data for the calendar event) and contact information of the user (e.g., information included in an address book of the digital calendar, information identifying one or more authorized users of the transaction account of the user, and/or the like) to determine the relationship. In some implementations, the transaction event management platform may determine a correlation between a type of participant (e.g., authorized user, unauthorized user, and/or the like) and an amount of money spent on a calendar event associated with that type of participant, as explained in more detail below.

While reference number 110 of FIG. 1A has been described with respect to accessing and analyzing the digital calendar stored by the calendar platform, the transaction event management platform may access and analyze the digital calendar stored by the user device, in a manner similar to the manner described above. In some implementations, the information regarding the digital calendar stored by the calendar platform may be a copy of information regarding the digital calendar stored by the user device. Alternatively, the calendar platform may store a first portion of the information regarding the digital calendar and the user device may store a second portion of the information regarding the digital calendar. For example, the calendar platform may store the work calendar portion of the digital calendar while the user device may store the information regarding the personal calendar portion of the digital calendar.

Additionally, while reference number 110 of FIG. 1A has been described with respect to the transaction event management platform accessing and analyzing the digital calendar stored by the calendar platform, the user (e.g., using the user device) may cause the digital calendar to be exported (from the calendar platform) and uploaded on to the transaction event management platform.

As further shown in FIG. 1A, and by reference number 115, the transaction event management platform may access a transaction log. For example, the transaction event management platform may access (e.g., based on the access information) the transaction account of the user and process (or analyze) the transactions associated with the transaction account of the user (e.g., transactions that are maintained and/or stored in the transaction log of the transaction account of the user). In some implementations, the transaction event management platform may process hundreds, thousands, or more transactions in hundreds, thousands, or more transaction accounts associated with hundreds, thousands, or more users. Accordingly, the transaction event management platform may perform one or more rigorous computerized processes to process the transactions of the transaction account.

The transaction event management platform may use the access information (received from the user device) to access the transaction account and, accordingly, the transaction log. In some implementations, the transaction event management platform may transmit a request (e.g., including the access information) to the transaction account platform to access the transaction account. The transaction account platform may authenticate the transaction event management platform (e.g., based on the access information) and identify information regarding the transaction account associated with the user (out of the information regarding transaction accounts associated with the plurality of users). For example, the access information may include information identifying the user and the transaction account platform may identify the information regarding the transaction account associated with the user based on the information identifying the user.

The transaction account platform may pre-process the information regarding transaction accounts associated with the plurality of users to reduce the quantity of transactions to be processed by the transaction event management platform. By reducing the quantity of transactions to be processed by the transaction event management platform, the transaction event management platform may conserve computing resources and/or network resources that may otherwise by consumed by processing the information regarding transaction accounts associated with other users that could have been filtered out as irrelevant.

The transaction account platform may authorize the transaction event management platform to analyze and monitor the information regarding the transaction account associated with the user based on authenticating the transaction event management platform (e.g., based on the access information) and based on identifying the information regarding the transaction account associated with the user. The information regarding the transaction account may include the transaction log which includes information identifying transactions (e.g., purchases, leases, rentals, and/or the like) associated with the user. The transaction event management platform may analyze the transaction log to identify characteristics of the transactions associated with the user.

In some implementations, the transaction event management platform may analyze every transaction (included in the transaction log) that is associated with the transaction account. In some implementations, the transaction event management platform may analyze a subset of the transactions that are associated with the transaction account. As an example, the transaction event management platform may pre-process the transactions to further reduce the quantity of transactions that are further processed to transactions associated with the calendar events of the user.

For instance, the transaction event management platform may identify one or more characteristics of a transaction (e.g., a date on which the transaction was conducted by the user, a time at which the transaction was conducted by the user, and/or the like) and identify one or more characteristics of the calendar events (e.g., a date associated with the calendar events, a time associated with the calendar events, and/or the like). The transaction event management platform may compare the one or more characteristics of the transaction and the one or more characteristics of the calendar events to determine whether the transaction is associated with one or more of the calendar events (e.g., to determine whether the transaction is an event transaction).

Accordingly, the transaction event management platform may not process a transaction unless the transaction event management platform identifies a likelihood that the transaction is associated with a calendar event. In this way, the transaction event management platform may conserve computing resources and/or network resources that may otherwise by consumed by processing transactions that could have been filtered out as irrelevant.

In some implementations, the transaction log may include (e.g., as characteristics of transactions) information identifying amounts of transactions, information identifying entities (e.g., merchants) associated with transactions, information identifying types of transactions, transaction identifiers (e.g., transaction numbers), information identifying transaction dates, information identifying transaction times, information identifying transaction locations, information indicating whether transactions cards were used, and/or the like.

As shown in FIG. 1A, the example transaction log illustrates a portion of the transactions for a period of time (e.g., for the month of June 2019). The example transaction log includes four transactions (e.g., historical transactions) within a threshold amount of time of Malik's birthday. The transactions may be identified as transaction “0003,” “0025,” “0050,” and “0174.” Transaction 0003 may have a date of execution of June 8 and a transaction amount of $62.00. Transaction 0025 may have a date of execution of June 9 and a transaction amount of $43.67. Transaction 0050 may have a date of execution of June 10 and a transaction amount of $60.00. Transaction 0074 may have a date of execution of June 11 and a transaction amount of $39.99.

In some implementations, the transaction event management platform may process hundreds, thousands, or more transactions in hundreds, thousands, or more transaction accounts associated with hundreds, thousands, or more users, and thus may provide big data capability. The big data handled by user profile scoring platform may be so voluminous and complex that traditional data processing applications cannot be used and/or that the big data cannot be processed objectively by a human actor.

In some implementations, the transaction event management platform may process the transaction log using a combination of processing techniques (e.g., after pre-processing the calendar data) to identify transactions included in the transaction log. For example, the transaction event management platform may process the transaction log using a text processing technique (e.g., a natural language processing technique, a text analysis technique, and/or the like), a code processing technique, and/or the like. In some implementations, the transaction event management platform may process the transaction log using an image processing technique (e.g., a computer vision technique, an optical character recognition (OCR) technique, and/or the like to identify text corresponding to transactions of the transaction log).

In some implementations, when processing the transaction log using the text processing technique, the transaction event management platform may process text of entries in the transaction log to identify terms, phrases, and/or the like included in the text (e.g., to identify event transactions). For example, the transaction event management platform may process the text of the transactions to identify terms and/or phrases that may likely identify event transactions.

In some implementations, when processing the transaction log using the code processing technique, the transaction event management platform may process code associated with the transaction log to identify event transactions included in the transaction log, to identify information related to the event transactions, and/or the like. For example, the transaction event management platform may analyze code (e.g., hypertext markup language (HTML) code, cascading style sheet (CSS) code, and/or the like) associated with the transaction log and/or transaction account platform, tags within the code (e.g., a div tag, an image tag, text-related tags, and/or the like) that are associated with the transactions, and/or the like. In some implementations, the historical transaction data may be anonymized training data that is used to train one or more machine learning models, as described in more detail below.

As further shown in FIG. 1A, and by reference number 120, the transaction event management platform may train a transaction event recognition model. For example, the transaction event management platform may train the transaction event recognition model to identify calendar events that involve event transactions. In some implementations, the transaction event management platform may train the transaction event recognition model with historical data.

The historical data may include historical calendar data associated with historical calendar events and historical transaction data associated with historical transactions. The historical calendar events may include previous calendar events of the digital calendar of the user, previous calendar events of another digital calendar of the user, and/or previous calendar events of one or more digital calendars of one or more other users (e.g., obtained from the calendar platform), and/or the like. The historical transactions may include previous transactions involving the transaction account of the user, previous transactions involving another transaction account of the user, previous transactions involving one or more transaction accounts of one or more other users (e.g., obtained from the transaction account platform), and/or the like.

In some implementations, the transaction event recognition model may be trained to determine whether a calendar event involves an event transaction based on an analysis of the historical calendar events and the historical transactions. For example, based on the historical calendar events and the historical transactions, the transaction event recognition model may identify characteristics of a calendar event that involves an event transaction. For instance, the transaction event recognition model may determine that a calendar event with a title or a description indicative of a social gathering (e.g., “birthday,” “anniversary,” “party,” “celebration,” and/or the like) is likely to be involved with an event transaction (e.g., a purchase of a gift for the social gathering). Similarly, the transaction event recognition model may determine that a calendar event associated with a type that includes travel, entertainment, or a meal is likely to be involved with an event transaction. Similarly, the transaction event recognition model may determine that a calendar event that includes information identifying a merchant is likely to be involved with an event transaction, and so on.

As an example, a first historical event (with a title or description indicative of a social gathering) may be associated with a first historical transaction that occurred on or close to the date and/or time of the historical transaction. Similarly, a second historical event (associated with a type that includes travel, entertainment, or a meal) may be associated with a second historical transaction that occurred on or close to the date and/or time of the historical transaction, and so on.

For example, as shown in FIG. 1A, a historical calendar event identifies Malik's birthday occurring on 6/12. As shown in FIG. 1A, historical transactions occurred within a few days of Malik's birthday (e.g., between 6/10 and 6/11). Based on analyzing the historical data, the transaction event recognition model may determine that historical transactions do not typically occur during other months. In this instance, the transaction event recognition model may determine that the historical transactions occurred because of Malik's birthday and determine that Malik's birthday is a calendar event that involves an event transaction.

The transaction event recognition model may further determine that the user spends more money during the particular month because Malik's birthday occurs during the particular month. For example, the transaction event recognition model may determine that the user spends approximately an additional one hundred dollars ($100) during the particular month (e.g., approximately an additional forty dollars ($40) at retail stores and approximately an additional sixty dollars ($60) at the grocery stores). The transaction event recognition model may determine a similar spending trend for another birthday calendar event occurring on a different month.

As another example, the transaction event recognition model may determine that the historical calendar data includes a plurality of instances of a historical calendar event with a title (or a description) indicating “Dinner with Tina and Jeff at Local Restaurant.” The transaction event recognition model may determine that the title or the description (of such calendar event) is indicative of a social gathering and, accordingly, is likely to be involved with an event transaction (e.g., a purchase of a meal). The transaction event recognition model may analyze the historical calendar data and determine the dates and times associated with the plurality of instances of such historical calendar events. The transaction event recognition model may analyze the historical transaction data to determine whether the historical transaction data includes historical transactions associated with the dates and times (associated with the plurality of instances of such historical calendar event). Based on identifying the historical transactions (associated with the dates and times), the transaction event recognition model may determine that the historical transactions (associated with the dates and times) are event transactions associated with the plurality of instances of the historical calendar event.

In some implementations, the transaction event management platform may analyze the historical transaction data to identify spending trends, analyze the historical transaction data to determine whether they correlate to any calendar events or correlate to a pattern of calendar events (e.g., recurring calendar events), and/or the like. In some implementations, the transaction event management platform may obtain the historical transaction data periodically (e.g., every week, every month, each time a new transaction occurs, and/or the like).

In some implementations, based on the historical calendar events and the historical transactions, the transaction event recognition model may determine that, for certain types of calendar events, transactions may occur before such calendar events are added to the digital calendar. For example, a transaction related to traveling accommodation (e.g., purchasing a plane ticket, booking a hotel reservation, and/or the like) may occur prior to a calendar event (related the travel accommodation) is added to the digital calendar. In other words, such transaction may be a prepaid transaction and may occur prior to future traveling plans occurring.

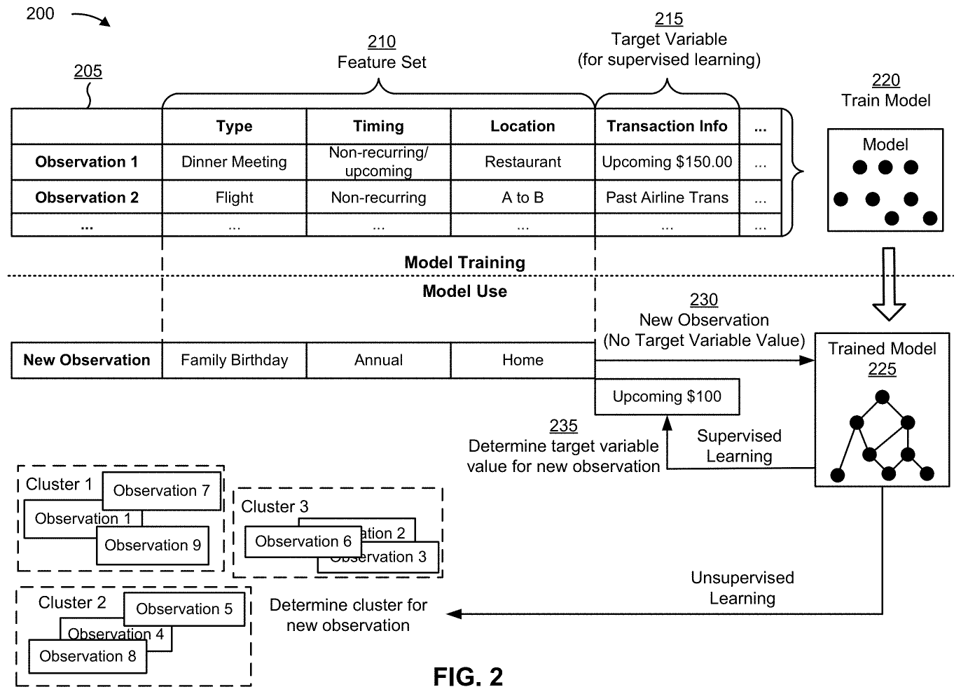

The transaction event management platform may train the transaction event recognition model in a manner similar to the manner described below in connection with FIG. 2. Alternatively, rather than training the transaction event recognition model, the transaction event management platform may obtain the transaction event recognition model from another system or device that trained the transaction event recognition model. In this case, the other system or device may obtain the historical data (e.g., the historical data discussed above) for use in training the transaction event recognition model, and may periodically receive additional data that the other system or device may use to retrain or update the transaction event recognition model. In some implementations, the transaction event management platform may periodically obtain additional data (e.g., additional historical calendar data, historical transaction data, and/or the line) that the transaction event management platform may use to retrain or update the transaction event recognition model, as described below.

As a result of training, the transaction event recognition model may be used to identify calendar events that involve event transactions. The transaction event management platform may apply the transaction event recognition model to a new observation in a manner similar to the manner described below in connection with FIG. 2. For example, using the historical data and a calendar event as inputs to the transaction event recognition model, the transaction event management platform may determine that the calendar event is associated with an event transaction or that the calendar event is not associated with an event transaction. For instance, the transaction event management platform may use the transaction event recognition model to determine a transaction score associated with a probability that the calendar event involves an event transaction.

As further shown in FIG. 1B, and by reference number 125, the transaction event management platform may identify a calendar event. In some implementations, based on the access information, the transaction event management platform may monitor the calendar data of the digital calendar (associated with the user) for changes to the calendar data. For example, the transaction event management platform may monitor the calendar data of the digital calendar to determine whether event data of a calendar event (e.g., data of the calendar event) has been added to the digital calendar.

For instance, the transaction event management platform may periodically (e.g., every day, every week, and/or the like) transmit a request (e.g., including the access information) to the calendar platform to identify one or more calendar events that have been added (e.g., newly added) to the calendar data. In some implementations, the request may identify a threshold period of time associated with calendar events to be obtained. For example, the request may cause the calendar platform to identity calendar events that occurred within the threshold period of time from receiving the request.

Based on the request, the transaction event management platform may receive the event data of the calendar event from the calendar platform. The frequency at which the request is transmitted may be based on historical data identifying a frequency at which the user adds calendar events to the digital calendar. In some implementations, the calendar platform may provide information identifying the frequency at which the user adds calendar events to the transaction event management platform when the calendar platform provides the information regarding the digital calendar (as explained above in connection with reference number 110 of FIG. 1A).

In some implementations, the calendar platform may provide the event data of the calendar event to the transaction event management platform without receiving the request. For example, the calendar platform may provide event data of calendar events periodically (e.g., every day, every week, and/or the like). The frequency at which the calendar platform provides the event data of the calendar events may be based on the historical data identify the frequency at which the user adds calendar events to the digital calendar.

In some implementations, the event data may be received, from the calendar platform, based on the application programming interface identifying that the calendar event was added to the digital calendar. The application programming interface may obtain, based on identifying that the calendar event was added, the event data.

As further shown in FIG. 1B, and by reference number 130, the transaction event management platform may determine that the calendar event is associated with a transaction. For example, the transaction event management platform may use the transaction event recognition model to determine whether the calendar event is associated with an event transaction. For instance, using the event data of the calendar event as an input to the transaction event recognition model, the transaction event management platform may determine whether the calendar event is associated with an event transaction. In some implementations, the transaction event management platform may determine, using the transaction event recognition model, a transaction score associated with a probability that the calendar event is associated with an event transaction.

For example, when determining the transaction score using the transaction event recognition model, the transaction event management platform may cause the transaction event recognition model to analyze metadata associated with the calendar event. The metadata may identify one or more characteristics of the calendar event. For example, the one or more characteristics may include a subject, a description, a date, a time, and/or the like of the calendar event. The transaction event recognition model may determine, based on the metadata, the one or more characteristics of the calendar event. The transaction event recognition model may determine, based on the one or more characteristics, the transaction score based on a probability that the one or more characteristics of the calendar event are associated with an event transaction.

As an example, assume that the historical calendar data identifies historical calendar events indicating lunches with Jason, a friend of the user. Further assume that such historical calendar events occur periodically (e.g., every three months). Further assume that the historical transaction data indicates that a portion of such historical calendar events involves event transactions. For example, assume that the historical transaction data indicates that seventy percent (70%) of such historical calendar events (indicating lunches with Jason) involve event transactions (and the remaining thirty percent (30%) do not involve event transactions). In this regard, for a calendar event indicating lunch with Jason, the transaction event management platform may determine, using the transaction event recognition model, a transaction score indicative of the portion of such historical calendar events that involve event transactions.

For example, for a calendar event indicating lunches with Jason, the transaction event management platform may determine, using the transaction event recognition model, a transaction score of seventy (70) which indicates a seventy percent probability that the calendar event is associated with an event transaction. In other words, in some implementations, the transaction score may be based on a portion of one or more instances of a historical calendar event that involve an event transaction.

As further shown in FIG. 1C, and by reference number 135, the transaction event management platform may determine transaction information associated with the calendar event. In some implementations, the transaction information may include information regarding a transaction value of the event transaction. For example, the transaction information may include information identifying a cost of the event transaction and information identifying a date and/or time when the event transaction is going to occur.

In some implementations, the transaction event management platform may determine whether the transaction score satisfies a score threshold prior to determining the transaction information. For example, the transaction event management platform may determine the transaction information when the transaction score satisfies the score threshold. In some examples, the transaction event management platform may cause, based on the transaction score satisfying the score threshold, a transaction analysis model to determine the transaction information associated with the calendar event based on an analysis of the transaction log of the transaction account of the user. The transaction analysis model may be the same as or similar to the transaction event recognition model described above with respect to FIGS. 1A and 1B, may be associated with the transaction event recognition model, may be included in or may include the transaction event recognition model, and/or the like.

In some implementations, the transaction analysis model may be trained based on historical data that includes historical transaction data associated with historical transactions (e.g., the historical transaction data discussed above). Additionally, the historical data (used to train the transaction analysis model) may further include historical calendar data associated with historical calendar events (e.g., the historical calendar data discussed above) to identify a correlation between a historical transaction and a historical calendar event. For example, the transaction analysis model may identify a particular historical transaction and may compare the particular historical transaction and the historical calendar events to identify a corresponding historical calendar event.

Based on an analysis of the historical data, the transaction analysis model may be trained to determine a spending trend based on a characteristic of the calendar event. For example, the transaction analysis model may determine that a first amount (e.g., for a transaction) is typically spent for a calendar event associated with a first characteristic, a second amount is typically spent for a calendar event associated with a second characteristic, a third amount is typically spent for a calendar event associated with a third characteristic, and so on. For instance, the transaction analysis model may determine that the first amount is typically spent for a calendar event associated with a particular type (e.g., entertainment, travel, meal, and/or the like), the second amount is typically spent for a calendar event associated with a particular category (e.g., personal, business, and/or the like), the third amount is typically spent for a calendar event associated with a particular merchant (e.g., personal, business, and/or the like), and so on.

As an example, based on an analysis of the historical data, the transaction analysis model may determine an amount typically spent for a historical calendar event with a title or a description indicating “Dinner with Tina and Jeff at Local Restaurant.” For example, based on the analysis of the historical data, the transaction analysis model may identify historical transactions in the amount of fifty dollars ($50) for instances of the historical calendar event with a title or a description indicating “Dinner with Tina and Jeff at Local Restaurant.” Accordingly, the transaction analysis model may predict, for an upcoming instance of such calendar event, that an amount of approximately fifty dollars ($50) will be spent.

As an example, based on an analysis of the historical data, the transaction analysis model may predict an amount that will be spent for the new calendar event associated with a historical characteristic (e.g., a characteristic identified in the historical data) and a non-historical characteristic (e.g., a characteristic that is not identified in the historical data). For example, assume that a new calendar event identifies purchasing plane tickets to a particular country in Africa (e.g., a country that the user has not previously traveled to). Further assume that the historical data includes one or more historical calendar events regarding purchasing plane tickets to one or more other countries in Africa.

In this instance, the historical characteristic may be a type of calendar event that includes traveling and the non-historical characteristic may be the location associated with the travel (e.g., the particular country that the user has not previously traveled to). In this regard, the transaction analysis model may identify transaction information associated with the one or more historical calendar events regarding purchasing plane tickets to the one or more other countries in Africa. For example, the transaction analysis model may identify the costs of the plane tickets, the costs of any additional travel accommodation (e.g., car rental, prepaid gas, and/or the like), the costs of luggage, and/or the like.

The transaction analysis model may use such transaction information to predict the cost associated with the new calendar event (associated with purchasing plane tickets to the particular country in Africa). In other words, the transaction analysis model may predict that the user will spend approximately the same amount that the user spent with respect to purchasing plane tickets to the one or more other countries in Africa.

The transaction analysis model may determine a correlation between a type of participant (e.g., a family member, an authorized user of the transaction account, a co-worker, a business associate, an unauthorized user of the transaction account, and/or the like) and an amount spent for a calendar event associated with that type of participant. For example, the transaction analysis model may be able to determine that a fourth amount is typically spent on a calendar event associated with a first type of participant, a fifth amount is typically spent on a calendar event associated with a second type of participant, and so. Additionally, the transaction analysis model may determine that different amounts are spent for different family members, different co-workers, and/or the like.

Based on the historical data, the transaction analysis model may identify a transaction pattern associated with timing of a calendar event. The transaction pattern may indicate whether the calendar event is associated with a transaction is a recurring transaction or a non-recurring transaction, indicate a frequency of occurrence of the recurring transaction (e.g., every week, every month, and/or the like), and/or the like.

Based on the historical data, the transaction analysis model may determine a transaction profile of a calendar event. The transaction profile may indicate whether the calendar event is associated with an unpaid transaction (e.g., a transaction that will be paid close or at the time of the event), is associated with a transaction associated with a particular type of participant, is associated with a recurring transaction, a non-recurring transaction, and/or the like. Additionally, or alternatively, based on the historical data, the transaction analysis model may determine a transaction pattern associated with a calendar event.

The transaction analysis model may be trained in a manner similar to the manner in which the transaction event recognition model is trained and described below in connection with FIG. 2. As a result of training, the transaction analysis model may be used to identify the transaction information associated with calendar events. The transaction event management platform may apply the transaction analysis model to a new observation in a manner similar to the manner described below in connection with FIG. 2. For example, using the historical data and a calendar event (identified based on monitoring the digital calendar of the user) and along the transaction log of the user as inputs to the transaction analysis model, the transaction event management platform may determine the transaction information associated with calendar events.

For instance, when determining the transaction information, the transaction event management platform may cause the transaction analysis model to determine the transaction profile of the calendar event and may analyze, based on the transaction profile, the transaction log to identify the transaction pattern associated with the calendar event. The transaction event management platform may determine previous transaction values (e.g., transaction costs) of previous transactions associated with the transaction pattern. The transaction event management platform may determine the transaction value based on an analysis of the previous transaction values. The analysis may include a cost analysis such as, for example, an average cost, a type of cost, and/or the like of the previous transaction values.

Alternatively, when determining the transaction information, the transaction event management platform causes the transaction analysis model to determine a type of transaction associated with the calendar event. For example, the transaction analysis model may determine that the calendar event involves a particular type of transaction such as, for example, a transaction that is a prepaid transaction (e.g., a transaction that occurs prior to the calendar event). The transaction analysis model may identify, based on determining that the calendar event involves the particular type of transaction, an entity identifier associated with the calendar event. For example, the entity identifier may identify a merchant that requires payment prior the calendar event (e.g., a hotel, a car rental company, and/or the like). The transaction analysis model may analyze the transaction log of the user to identify, based on the entity identifier, a log entry (in the transaction log) that is associated with the entity identifier. The transaction analysis model may determine that a transaction value (for a transaction associated with the calendar event) corresponds to a transaction log value of the log entry. The transaction information may include the transaction value.

As further shown in FIG. 1C, and by reference number 140, the transaction event management platform may perform one or more actions associated with the calendar event. In some implementations, the one or more actions may include the transaction event management platform forecasting a status of the transaction account during a time period of the calendar event. For example, the transaction event management platform may forecast a status of the transaction based on the transaction information. For example, based on the transaction information, the transaction event management platform may predict when the transaction is to occur, predict a cost associated with the transaction, predict an impact on the transaction account and/or on a budget associated with the user when the transaction occurs, and/or the like.

With respect to the impact on the transaction account and/or on the budget associated with the user, the transaction event management platform may determine whether the transaction account will have sufficient funds for the transaction (e.g., based on other transactions that typically occur during the time period), whether the other transactions need to be canceled or postponed, whether the calendar event needs to be canceled or postponed, whether the user needs to take one or more other actions, and/or the like. For instance, the transaction event management platform may forecast different balances of the transaction account based on whether the transaction and/or the other transactions occur. The time period may include a month during which the calendar event occurs, a statement period (associated with the transaction account) during which the calendar event occurs, and/or the like.

Accordingly, by forecasting the status of the transaction account and/or the budget associated with the user, the transaction event management platform may prevent an overdraft of the transaction account of the user (e.g., may implement an overdraft protection for the transaction account of the user). By preventing the overdraft of the transaction account of the user, the transaction event management platform may conserve computing resources (e.g., processing resources, memory resources, communication resources, and/or the like), networking resources, and/or the like that would have otherwise been used to cause the transaction account to incur an overdraft fee, notify the user of the overdraft of the transaction account, establish communications with the user to discuss the overdraft of the transaction account, and/or the like.

In some implementations, the one or more actions may include the transaction event management platform generating, based on the status, a forecast report associated with the time period of the calendar event. For example, the forecast report may include information predicting when the transaction is to occur, predicting a cost associated with the transaction, predicting the impact on the transaction account and/or the budget when the transaction occurs, and/or the like. The forecast report may include the transaction information and information identifying forecasted transactions associated with the transaction account, forecasted balances associated with the transaction account, forecasted information regarding whether the user will be under or over spending budgets for the time period, and/or the like based on the transaction.

In some implementations, the transaction event management platform may receive a user input, associated with the transaction value (included in the transaction information), as a response to the forecast report. For example, the user input may be received from the user device and may indicate whether the user desires to cancel the calendar event, postpone the calendar event, cancel a transaction that typically occurs during the time period, postpone such transaction, and/or the like. In this regard, the user may be able to adjust a budget and/or a spending trend during the time period based on the transaction value.

By generating and providing the forecast report, the transaction event management platform may prevent an overdraft of the transaction account of the user (e.g., may implement an overdraft protection of the transaction account of the user). By preventing the overdraft of the transaction account of the user, the transaction event management platform may conserve computing resources (e.g., processing resources, memory resources, communication resources, and/or the like), networking resources, and/or the like that would have otherwise been used to cause the transaction account to incur an overdraft fee, notify the user of the overdraft of the transaction account, establish communications with the user to discuss the overdraft of the transaction account, and/or the like.

In some implementations, the one or more actions may include the transaction event management platform notifying a fraud analysis platform of the calendar event and the transaction information to prevent locking of the transaction account. For example, the transaction event management platform may provide a notification to the fraud analysis platform. The fraud analysis platform may include one or more devices that are configured to monitor the transaction account for fraudulent activity. In some implementations, the notification may identify a date and/or a time of the calendar event and the transaction information. The transaction information may indicate that the transaction (e.g., an event transaction) will occur on or close to the date and/or time of the calendar event and that the transaction will cost a particular amount.

Assume that the calendar event is an atypical calendar event and that the transaction, associated with the calendar event, is an atypical transaction (e.g., based on the amount associated with the transaction, based on the location associated with the calendar event, based on the transaction history of the user, based on the costs of the transaction, and/or the like). In this instance, the fraud analysis platform would typically analyze the transaction and determine that the transaction is an atypical transaction and, accordingly, that the transaction is fraudulent.

However, assume that the transaction event management platform has provided the notification to the fraud analysis platform. In this regard, based on the notification, the fraud analysis platform may determine that the calendar event is to occur on the date and/or the time (identified in the notification). Based on the transaction information, the fraud analysis platform may determine that the calendar event involves the atypical transaction, that such atypical transaction will occur on or close to the date and/or the time, and that such atypical transaction will cost approximately the particular amount identified in the transaction information. In this regard, the fraud analysis system will not erroneously determine that such atypical transaction is a fraudulent when such transaction occurs on the date and/or the time (identified in the notification) and costs approximately the particular amount. Accordingly, the fraud analysis system may enable such atypical transaction to be conducted on or close to the date and/or the time and for the particular amount.

Accordingly, by notifying the fraud analysis platform, the transaction event management platform may conserve computing resources (e.g., processing resources, memory resources, communication resources, and/or the like), networking resources, and/or the like that would have otherwise been used to erroneously decline the transaction, erroneously determine that the transaction is part of a fraudulent activity, investigate the fraudulent activity, report the fraudulent activity, contact a user regarding the fraudulent activity, take remedial measures associated with declining transactions and associated with determining that transactions are fraudulent, and/or the like.

Additionally, by notifying the fraud analysis platform, the transaction event management platform may improve the reliability of identifying valid transactions and fraudulent transactions, thereby preserving computing resources, network resources, and/or the like that would have otherwise been used to erroneously identify valid transactions and fraudulent transactions.

In some implementations, the one or more actions may include the transaction event management platform retraining the transaction event recognition model based on the user feedback (e.g., user input) associated with the forecast report. By retraining the transaction event recognition model, the transaction event management platform may improve the accuracy of the transaction event recognition model in determining whether a calendar event is associated with an event transaction and in determining a transaction value of the event transaction. Retraining the transaction event recognition model in this manner may improve speed and efficiency of the transaction event recognition model and conserve computing resources, networking resources, and/or the like that would have otherwise been used to erroneously decline transactions, erroneously determine that transactions are part of a fraudulent activity, investigate the fraudulent activity, report the fraudulent activity, contact a user regarding the fraudulent activity, take remedial measures associated with declining transactions and associated with determining that transactions are fraudulent, and/or the like.

While aspects of the examples herein have been described with respect to a user, aspects of the present disclosure may be applicable to a business.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-IC may perform one or more functions described as being performed by another set of devices shown in FIGS. 1A-1C.

FIG. 2 is a diagram illustrating an example 200 of training and using a machine learning model in connection with event analysis based on transaction data associated with a user. The machine learning model training and usage described herein may be performed using a machine learning system. The machine learning system may include or may be included in a computing device, a server, a cloud computing environment, and/or the like, such as the transaction event management platform, the user device, the calendar platform, and/or the transaction account platform described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the transaction event management platform, the user device, the calendar platform, and/or the transaction account platform, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the transaction event management platform, the user device, the calendar platform, and/or the transaction account platform. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of type, a second feature of timing, a third feature of location, and so on. As shown, for a first observation, the first feature may have a value of dinner meeting, the second feature may have a value of non-recurring/upcoming, the third feature may have a value of restaurant, and so on. These features and feature values are provided as examples, and may differ in other examples. For example, the feature set may include one or more of the following features: event transaction, a transaction profile of a calendar event, a transaction pattern associated with the calendar event, a transaction value, a merchant identifier associated with the calendar event, a type of the calendar event, a category of the calendar event, a participant of the calendar event, other characteristics of the calendar event, and/or the like.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, labels, and/or the like), may represent a variable having a Boolean value, and/or the like. A target variable may be associated with a target variable value, and a target variable value may be specific to an observation. In example 200, the target variable is transaction info (or transaction information), which has a value of upcoming $150.00 for the first observation.

The feature set and target variable described above are provided as examples, and other examples may differ from what is described above. For example, for a target variable of event transaction, the feature set may include a calendar event, a type of the calendar event, a category of the calendar event, a participant of the calendar event, other characteristics of the calendar event, and/or the like.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of family birthday, a second feature of annual, a third feature of home, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of upcoming $100 for the target variable of transaction info for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like. The first recommendation may include, for example, approve upcoming $100. The first automated action may include, for example, approving the $100 spending for the family birthday event.

As another example, if the machine learning system were to predict a value of upcoming $200 spend for the target variable of transaction info, then the machine learning system may provide a second (e.g., different) recommendation (e.g., decline $100 spend) and/or may perform or cause performance of a second (e.g., different) automated action (e.g., declining the $100 spend).

In some implementations, the recommendation and/or the automated action associated with the new observation may be based on a target variable value having a particular label (e.g., classification, categorization, and/or the like), may be based on whether a target variable value satisfies one or more threshold (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to an event analysis based on transaction data associated with a user. The machine learning system enables recognition and/or identification of tens, hundreds, thousands, or millions of features and/or feature values for tens, hundreds, thousands, or millions of observations, thereby increasing accuracy and consistency and reducing delay associated with an event analysis based on transaction data associated with a user relative to requiring computing resources to be allocated for tens, hundreds, or thousands of operators to manually an event analysis based on transaction data associated with a user using the features or feature values.

As indicated above, FIG. 2 is provided as an example. Other examples may differ from what is described in connection with FIG. 2.

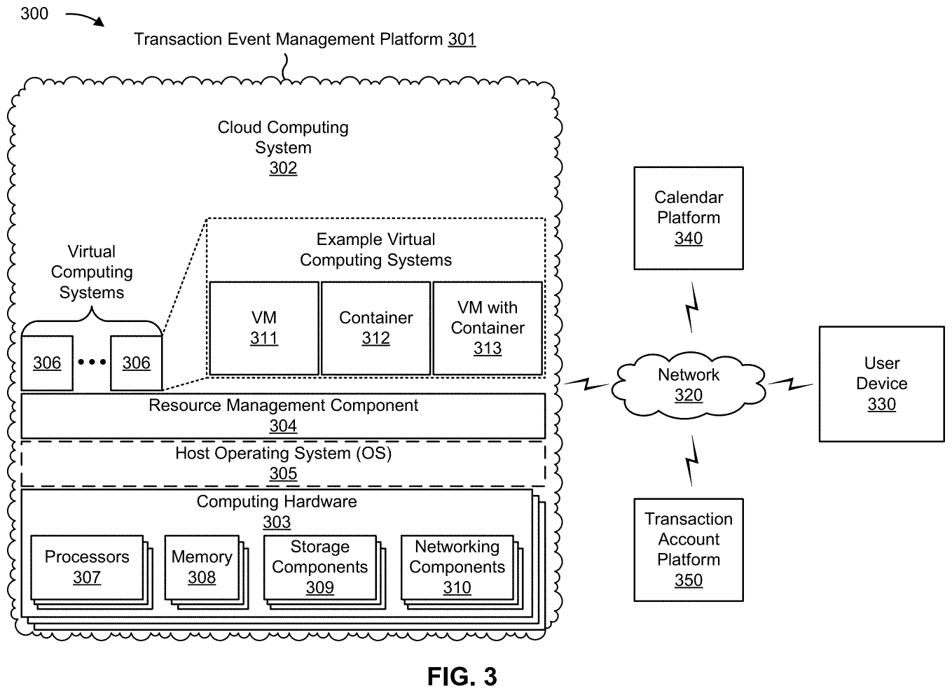

FIG. 3 is a diagram of an example environment 300 in which systems and/or methods described herein may be implemented. As shown in FIG. 3, environment 300 may include a transaction event management platform 301, which may include one or more elements of and/or may execute within a cloud computing system 302. The cloud computing system 302 may include one or more elements 303-313, as described in more detail below. As further shown in FIG. 3, environment 300 may include a network 320, a user device 330, a calendar platform 340, and/or a transaction account platform 350. Devices and/or elements of environment 300 may interconnect via wired connections and/or wireless connections.

The cloud computing system 302 includes computing hardware 303, a resource management component 304, a host operating system (OS) 305, and/or one or more virtual computing systems 306. The resource management component 304 may perform virtualization (e.g., abstraction) of computing hardware 303 to create the one or more virtual computing systems 306. Using virtualization, the resource management component 304 enables a single computing device (e.g., a computer, a server, and/or the like) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

Computing hardware 303 includes hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, and/or the like) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, a hybrid environment 313 that includes a virtual machine and a container, and/or the like. A virtual computing system 306 may execute one or more applications using a file system that includes binary files, software libraries, and/or other resources required to execute applications on a guest operating system (e.g., within the virtual computing system 306) or the host operating system 305.

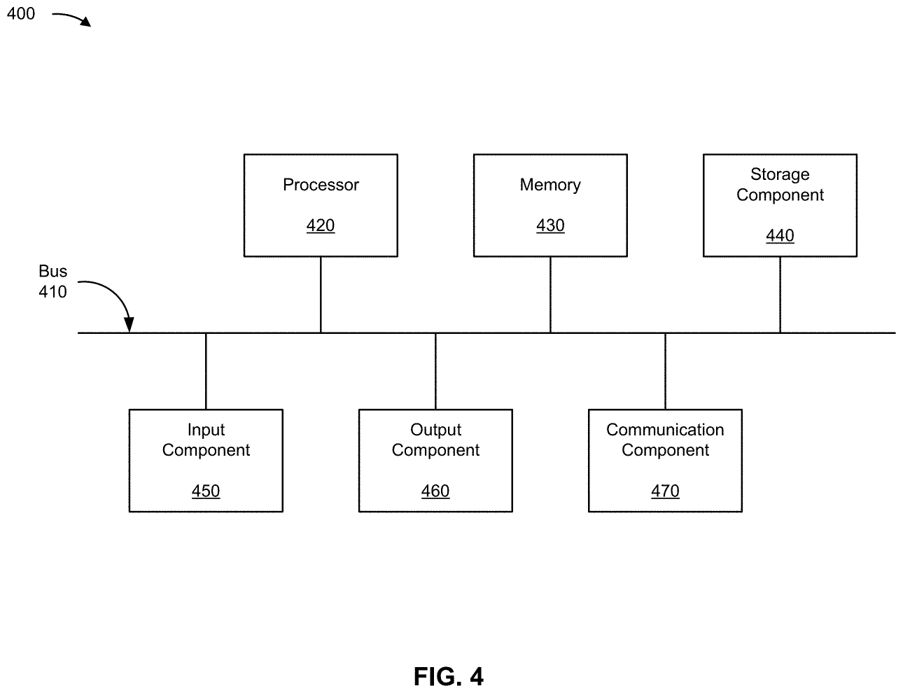

Although the transaction event management platform 301 may include one or more elements 303-313 of the cloud computing system 302, may execute within the cloud computing system 302, and/or may be hosted within the cloud computing system 302, in some implementations, the transaction event management platform 301 may not be cloud-based (e.g., may be implemented outside of a cloud computing system) or may be partially cloud-based. For example, the transaction event management platform 301 may include one or more devices that are not part of the cloud computing system 302, such as device 400 of FIG. 4, which may include a standalone server or another type of computing device. The transaction event management platform 301 may perform one or more operations and/or processes described in more detail elsewhere herein.

Network 320 includes one or more wired and/or wireless networks. For example, network 320 may include a cellular network, a public land mobile network (PLMN), a local area network (LAN), a wide area network (WAN), a private network, the Internet, and/or the like, and/or a combination of these or other types of networks. The network 320 enables communication among the devices of environment 300.

The user device 330 may include one or more devices capable of receiving, generating, storing, processing, and/or providing information, such as information described herein. For example, user device 330 may include a mobile phone (e.g., a smart phone, a radiotelephone, and/or the like), a laptop computer, a tablet computer, a desktop computer, a handheld computer, a gaming device, a wearable communication device (e.g., a smart watch, a pair of smart glasses, a heart rate monitor, a fitness tracker, smart clothing, smart jewelry, a head mounted display, and/or the like), or a similar type of device. In some implementations, user device 330 receives information from and/or transmit information to transaction event management platform 301.

The calendar platform 340 may include one or more devices capable of receiving, generating, storing, processing, and providing information associated with digital calendars. For example, the calendar platform 340 may be associated with one or more server devices that include a communication interface that allows the calendar platform 340 to receive information from and/or transmit information to other devices in environment 300. In some implementations, the calendar platform 340 may include and/or have access to a data structure used to maintain one or more digital calendars of one or more users, a transaction log of an account of the user, profile information associated with the user, preferences associated with the one or more users, and/or the like.

The transaction account platform 350 includes one or more devices capable of receiving, generating, storing, processing, and providing information associated with managing a transaction account of a user. For example, the transaction account platform 350 may be associated with one or more server devices that include a communication interface that allows the transaction account platform 350 to receive information from and/or transmit information to other devices in environment 300. In some implementations, the transaction account platform 350 may include and/or have access to a data structure used to maintain one or more transaction logs of one or more accounts of one or more users, profile information associated with the one or more users, preferences associated with the one or more users, and/or the like.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to transaction event management platform 301, user device 330, calendar platform 340, and/or transaction account platform 350. In some implementations, transaction event management platform 301, user device 330, calendar platform 340, and/or transaction account platform 350 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, an actuator, and/or the like. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, an antenna, and/or the like.

Device 400 may perform one or more processes described herein. For example, a non-transitory computer-readable medium (e.g., memory 430 and/or storage component 440) may store a set of instructions (e.g., one or more instructions, code, software code, program code, and/or the like) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

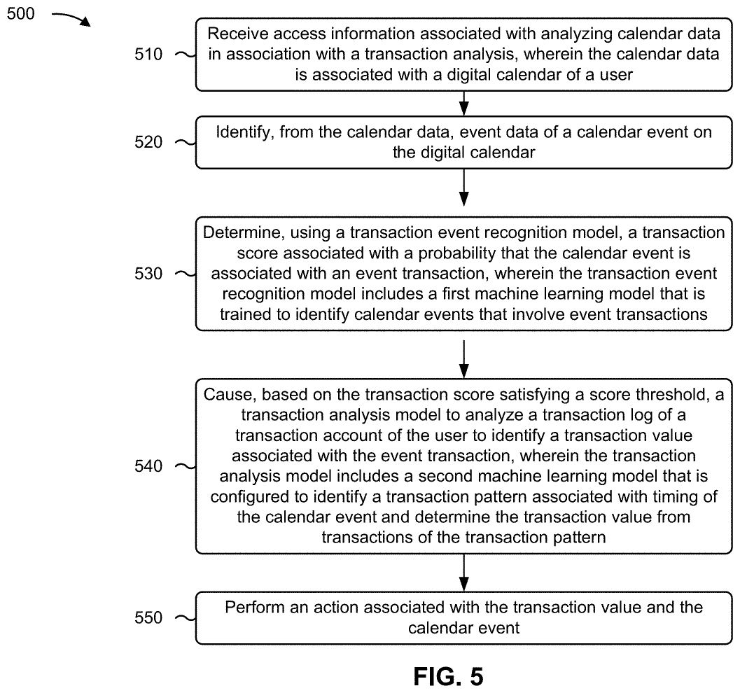

FIG. 5 is a flowchart of an example process 500 associated with event analysis based on transaction data associated with a user. In some implementations, one or more process blocks of FIG. 5 may be performed by a transaction event management platform (e.g., a transaction event management platform 301). In some implementations, one or more process blocks of FIG. 5 may be performed by another device or a group of devices separate from or including the device, such as a user device (e.g., user device 330), a calendar platform (e.g., calendar platform 340), and/or a transaction account platform (e.g., transaction account platform 350). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include receiving access information associated with analyzing calendar data in association with a transaction analysis, wherein the calendar data is associated with a digital calendar of a user (block 510). For example, the device may receive access information associated with analyzing calendar data in association with a transaction analysis, as described above. In some implementations, the calendar data is associated with a digital calendar of a user.

As further shown in FIG. 5, process 500 may include identifying, from the calendar data, event data of a calendar event on the digital calendar (block 520). For example, the device may identify, from the calendar data, event data of a calendar event on the digital calendar, as described above.

As further shown in FIG. 5, process 500 may include determining, using a transaction event recognition model, a transaction score associated with a probability that the calendar event is associated with an event transaction, wherein the transaction event recognition model includes a first machine learning model that is trained to identify calendar events that involve event transactions (block 530). For example, the device may determine, using a transaction event recognition model, a transaction score associated with a probability that the calendar event is associated with an event transaction, as described above. In some implementations, the transaction event recognition model includes a first machine learning model that is trained to identify calendar events that involve event transactions.

As further shown in FIG. 5, process 500 may include causing, based on the transaction score satisfying a score threshold, a transaction analysis model to analyze a transaction log of a transaction account of the user to identify a transaction value associated with the event transaction, wherein the transaction analysis model includes a second machine learning model that is configured to identify a transaction pattern associated with timing of the calendar event and determine the transaction value from transactions of the transaction pattern (block 540). For example, the device may cause, based on the transaction score satisfying a score threshold, a transaction analysis model to analyze a transaction log of a transaction account of the user to identify a transaction value associated with the event transaction, as described above. In some implementations, the transaction analysis model includes a second machine learning model that is configured to identify a transaction pattern associated with timing of the calendar event and determine the transaction value from transactions of the transaction pattern.

As further shown in FIG. 5, process 500 may include performing an action associated with the transaction value and the calendar event (block 550). For example, the device may perform an action associated with the transaction value and the calendar event, as described above.

Process 500 may include additional implementations, such as any single implementation or any combination of implementations described below and/or in connection with one or more other processes described elsewhere herein.

In a first implementation, the access information comprises a user input that authorizes an analysis of the digital calendar and the transaction log, further comprising prior to identifying the calendar event, performing a verification process to verify that the user provided the user input, wherein the digital calendar and the transaction log are analyzed based on the verification process.

In a second implementation, alone or in combination with the first implementation, the transaction event recognition model is trained based on calendar data associated with historical calendar events and transaction data associated with historical transactions, and wherein the transaction analysis model is trained based on the transaction data associated with the historical transactions.

In a third implementation, alone or in combination with one or more of the first and second implementations, the historical calendar events include previous calendar events of the digital calendar and the historical transactions include previous transactions involving the transaction account.

In a fourth implementation, alone or in combination with one or more of the first through third implementations, determining the transaction score, using the transaction analysis model, comprises causing the transaction analysis model to analyzing metadata associated with the calendar event, determining, based on the metadata, a characteristic of the calendar event, and determining, based on the characteristic, the transaction score based on a probability that the characteristic of the calendar event is associated with a transaction.

In a fifth implementation, alone or in combination with one or more of the first through fourth implementations, performing the action comprises at least one of forecasting, based on the transaction value, a status of the transaction during a time period of the calendar event, generating, based on the status, a forecast report associated with the time period, and providing the forecast report to a user device associated with the user.

In a sixth implementation, alone or in combination with one or more of the first through fifth implementations, performing the action comprises providing, based on the transaction value, a forecast report, associated with a time period of the calendar event, that forecasts a status of the transaction account during the time period, receiving a user input, associated with the transaction value, as a response to the forecast report, and retraining at least one of the first machine learning model or the second machine learning model based on the user input.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, etc., depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a device, access information associated with analyzing calendar data in association with a transaction analysis,
wherein the calendar data is associated with a digital calendar of a user;
identifying, by the device and from the calendar data, event data of a calendar event on the digital calendar;
determining, by the device and using a transaction event recognition model, a transaction score associated with a probability that the calendar event is associated with an event transaction,
wherein the transaction event recognition model includes a first machine learning model that is trained to identify calendar events that involve event transactions;
causing, by the device and based on the transaction score satisfying a score threshold, a transaction analysis model to analyze a transaction log of a transaction account of the user to identify a transaction value associated with the event transaction,
wherein the transaction analysis model includes a second machine learning model that is configured to identify a transaction pattern associated with timing of the calendar event and determine the transaction value from transactions of the transaction pattern; and
performing, by the device, an action associated with the transaction value and the calendar event.

2. The method of claim 1, wherein the access information comprises a user input that authorizes an analysis of the digital calendar and the transaction log, further comprising:
prior to identifying the calendar event, performing a verification process to verify that the user provided the user input,
wherein the digital calendar and the transaction log are analyzed based on the verification process.

3. The method of claim 1, wherein the transaction event recognition model is trained based on calendar data associated with historical calendar events and transaction data associated with historical transactions, and
wherein the transaction analysis model is trained based on the transaction data associated with the historical transactions.

4. The method of claim 3, wherein the historical calendar events include previous calendar events of the digital calendar and the historical transactions include previous transactions involving the transaction account.

5. The method of claim 1, wherein determining the transaction score, using the transaction analysis model, comprises causing the transaction analysis model to:
analyze metadata associated with the calendar event;
determine, based on the metadata, a characteristic of the calendar event; and
determine, based on the characteristic, the transaction score based on a probability that the characteristic of the calendar event is associated with a transaction.

6. The method of claim 1, wherein performing the action comprises at least one of:
forecasting, based on the transaction value, a status of the transaction during a time period of the calendar event;
generating, based on the status, a forecast report associated with the time period; and
providing the forecast report to a user device associated with the user.

7. The method of claim 1, wherein performing the action comprises:
providing, based on the transaction value, a forecast report, associated with a time period of the calendar event, that forecasts a status of the transaction account during the time period;
receiving a user input, associated with the transaction value, as a response to the forecast report; and
retraining at least one of the first machine learning model or the second machine learning model based on the user input.

8. A device, comprising:
one or more memories; and
one or more processors, communicatively coupled to the one or more memories, configured to:
monitor calendar data of a digital calendar associated with a user;
identify, from the calendar data, event data of a calendar event on the digital calendar;
determine, using a transaction event recognition model, a transaction score associated with a probability that the calendar event is associated with an event transaction,
wherein the transaction event recognition model is trained based on calendar data associated with historical calendar events and first transaction data associated with first historical transactions;
cause, based on the transaction score satisfying a score threshold, a transaction analysis model to determine transaction information associated with the calendar event based on an analysis of a transaction log of a transaction account of the user,
wherein the transaction analysis model is trained based on second transaction data associated with second historical transactions; and
perform, based on the transaction information, an action associated with forecasting a status of the transaction account during a time period of the calendar event.

9. The device of claim 8, wherein the one or more processors are further configured to, prior to monitoring the calendar data:
receive, from the user, access information associated with monitoring the calendar data and analyzing the transaction log,
wherein the access information includes user information that enables access to the digital calendar and the transaction account.

10. The device of claim 8, wherein the historical calendar events are associated with the digital calendar, and the first historical transactions are associated with previous transactions of the transaction account.

11. The device of claim 10, wherein the second historical transaction are associated with the previous transactions of the transaction account and other previous transactions of other transaction accounts associated with other users.

12. The device of claim 8, wherein the one or more processors, when determining the transaction score, using the transaction event recognition model, are configured to cause the transaction event recognition model to:
analyze, using a natural language processing model, a description of the calendar event;
determine, based on analyzing the description, a characteristic of the calendar event; and
determine, based on the characteristic, the transaction score based on a probability that the characteristic of the calendar event is associated with a transaction.

13. The device of claim 8, wherein the transaction information includes a transaction value for a transaction of the calendar event, and
wherein the one or more processors, when causing the transaction analysis model to determine the transaction information, are configured to cause the transaction analysis model to:
determine a transaction profile of the calendar event;
analyze, based on the transaction profile, the transaction log to identify a transaction pattern associated with the calendar event;
determine previous transaction values of previous transactions of the transaction pattern; and
determine the transaction value based on an analysis of the previous transaction values.

14. The device of claim 8, wherein the transaction information includes a transaction value for a transaction of the calendar event, and
wherein the one or more processors, when causing the transaction analysis model to determine the transaction information, are configured to cause the transaction analysis model to:
determine that the calendar event involves a particular type of transaction;
identify, based on determining that the calendar event involves the particular type of transaction, an entity identifier associated with the calendar event;
identify, based on the entity identifier, a log entry in the transaction log that is associated with the entity identifier; and
determine that the transaction value corresponds to a transaction log value of the log entry.

15. A non-transitory computer-readable medium storing a set of instructions, the set of instructions comprising:
one or more instructions that, when executed by one or more processors of a device, cause the device to:
receive event data associated with a calendar event of a digital calendar of a user;
determine, using a machine learning model, a transaction score associated with a probability that the calendar event involves an event transaction,
wherein the machine learning model is trained based on calendar data associated with historical calendar events and transaction data associated with historical transactions;
cause, based on the transaction score satisfying a score threshold, the machine learning model to analyze a transaction log of a transaction account of the user to identify transaction information associated with the calendar event; and
perform an action associated with the transaction information and the calendar event.

16. The non-transitory computer-readable medium of claim 15, wherein, prior the one or more processors receiving the event data, the one or more instructions, when executed by the one or more processors, further cause the one or more processors to:
receive, from a user device of the user, access information to enable an application programming interface to access the digital calendar and the transaction account,
wherein the event data is received based on the application programming interface:
identifying that the calendar event was added to the digital calendar, and
obtaining, based on identifying that the calendar event was added, the event data.

17. The non-transitory computer-readable medium of claim 15, wherein the historical calendar events are associated with the digital calendar of the user and other digital calendars of other users, and
wherein the historical transactions are associated with the transaction account and other transaction accounts associated with the other users.

18. The non-transitory computer-readable medium of claim 15, wherein the transaction information includes a transaction value for one or more transactions of the calendar event, and
wherein the one or more instructions, that cause the device to cause the machine learning model to analyze the transaction log, cause the device to cause the machine learning model to:
determine a transaction profile of the calendar event;
analyze, based on the transaction profile, the transaction log to identify a transaction pattern associated with the calendar event;
determine previous transaction values of previous transactions of the transaction pattern; and
determine the transaction value based on an analysis of the previous transaction values.

19. The non-transitory computer-readable medium of claim 15, wherein the transaction information includes a transaction value for one or more transactions of the calendar event, and
wherein the one or more instructions, that cause the device to cause the machine learning model to analyze the transaction log, cause the device to cause the machine learning model to:
determine that the calendar event involves a prepaid transaction;
identify, based on determining that the calendar event involves the prepaid transaction, an entity identifier associated with the calendar event;
identify, based on the entity identifier, a log entry in the transaction log that is associated with the prepaid transaction; and
determine that the transaction value corresponds to a transaction log value of the log entry.

20. The non-transitory computer-readable medium of claim 15, wherein the one or more instructions, that cause the device to perform the action, cause the device to:
forecast, based on the transaction information, a status of the transaction during a time period of the calendar event;
generate, based on the status, a forecast report associated with the time period;
provide the forecast report to a user device associated with the user;
provide a notification to a fraud analysis platform that is configured to monitor the transaction account for fraudulent activity,
wherein the notification identifies a date of the calendar event and the transaction information; or
retrain the machine learning model based on received user feedback associated with the transaction information.
